(19) United States
(12) Patent Application Publication
(10) Pub. No.: US 2008/0211870 A1
(43) Pub. Date: Sep. 4, 2008

(54) LIQUID EJECTING HEAD UNIT AND METHOD OF MANUFACTURING LIQUID EJECTING HEAD UNIT

(75) Inventors: Hiroshige OWAKI, Okaya-shi (JP); Yuichi WATANABE, Matsumoto-shi (JP); Wataru TAKAHASHI, Chino-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/039,301

(22) Filed: Feb. 28, 2008

(30) Foreign Application Priority Data
Mar. 1, 2007 (JP) 2007-052077

(51) Int. Cl. B21D 53/76; B41J 2/135

(52) U.S. Cl. 347/45; 29/890.1

(57) ABSTRACT

A method of manufacturing a liquid ejecting head unit which includes a liquid ejecting head having a liquid ejection surface through which a nozzle opening is opened to eject a liquid and a support member adhered onto the liquid ejection surface of the liquid ejecting head by an adhesive, the method including: forming a lyophobic film on the liquid ejection surface; forming a non-lyophobic area having no lyophobic film in an area in which the liquid ejection surface formed with the lyophobic film is adhered to the support member; performing primer processing of coating a primer liquid onto the non-lyophobic area; and adhering the support member to the non-lyophobic area of the liquid ejection surface using an adhesive.

### BACKGROUND

1. Technical Field

The present invention relates to a liquid ejecting head unit which includes a liquid ejecting head for ejecting a liquid through a nozzle opening and a support member attached onto a liquid ejection surface of the liquid ejecting head, and a method of manufacturing the liquid ejecting head unit.

2. Related Art

For example, as a ink jet printing head unit (hereinafter, referred to as a head unit) including an ink jet printing head for ejecting ink as a liquid, there is a printing head unit which includes the ink jet printing head having a liquid ejection surface to which a nozzle opening is opened to eject the ink and a support member such as a fixing plate attached onto the liquid ejection surface of the ink jet printing head by an adhesive (for example, see JP-A-2005-096419 (pages 7 to 12 and FIGS. 1 to 3).

If the head unit is provided with a lyophobic film on the liquid ejection surface, adhesive intensity between the liquid ejection surface and the support member may deteriorate. In view of such a problem, a non-lyophobic area in which the lyophobic film is removed in an adhesive area of the liquid ejection surface and the support member is formed.

However, the liquid ejecting head and the support member may not be sufficiently adhered just by forming the non-lyophobic area on the liquid ejection surface of the liquid ejecting head and adhering the support to the non-lyophobic area of the liquid ejection head member by use of the adhesive. Accordingly, there arises a problem that the liquid ejecting head and the support member are detached from each other.

### SUMMARY

An advantage of some aspects of the invention is that it provides a liquid ejecting head unit and a method of manufacturing the liquid ejecting head unit in which strengthening adhesive intensity between a liquid ejecting head and a support member is improved.

According to an aspect of the invention, there is provided a method of manufacturing a liquid ejecting head unit which includes a liquid ejecting head having a liquid ejection surface through which a nozzle opening is opened to eject a liquid and a support member adhered onto the liquid ejection surface of the liquid ejecting head by an adhesive. The method includes: forming a lyophobic film on the liquid ejection surface; forming a non-lyophobic area having no lyophobic film in an area in which the liquid ejection surface formed with the lyophobic film is adhered to the support member; performing primer processing of coating a primer liquid onto the non-lyophobic area; and adhering the support member to the non-lyophobic area of the liquid ejection surface using an adhesive.

According to such an aspect, it is possible to improve adhesion intensity and prevent peeling by forming the non-lyophobic area on the liquid ejection surface of the liquid ejecting head, performing the primer processing of the non-lyophobic area, adhering the support member by the adhesive. Moreover, it is possible to form the lyophobic film in a desired area easily and with high accuracy by forming the lyophobic film across the liquid ejection surface and removing the lyophobic film to form the non-lyophobic area.

In a method of manufacturing a liquid ejecting head unit described above, the forming of the lyophobic film may include forming an underlying film across the liquid ejection surface and forming a lyophobic film formed of a metal alkoxide molecular film on the underlying film. With such a configuration, the lyophobic film having excellent adhesion property, friction-resistant property, and lyophobic property can be realized on the liquid ejection surface so as to be thinner than a known lyophobic film. Accordingly, it is possible to improve a liquid ejection property.

In a method of manufacturing a liquid ejecting head unit described above, the forming of the non-lyophobic area may include removing only the molecular film formed on the underlying film of the liquid ejection surface. With such a configuration, it is not necessary to remove the underlying film or selectively form the underlying film only in a predetermined area. Accordingly, it is possible to simplify a manufacturing process and also reduce manufacturing cost.

In a method of manufacturing a liquid ejecting head unit described above, the liquid ejecting head may include a nozzle plate in which the nozzle opening is formed and a passage forming board which is adhered onto a surface opposite the liquid ejection surface of the nozzle plate by an adhesive and has a liquid passage. In addition, the forming of the lyophobic film may include forming the lyophobic film on the liquid ejection surface of the nozzle plate and on the surface opposite the liquid ejection surface. In addition, the forming of the non-lyophobic area may include forming the non-lyophobic area in the adhesion area of the liquid ejection surface to the support member and on the surface opposite the liquid ejection surface. With such a configuration, it is possible to improve adhesion intensity between the passage forming board and the nozzle plate by forming the non-lyophobic area in the adhesion area of the nozzle plate to the passage forming board as well.

In a method of manufacturing a liquid ejecting head unit described above, the forming of the lyophobic film may include forming an underlying film only on the liquid ejection surface and forming a lyophobic film formed of a metal alkoxide molecular film across the surface of the nozzle plate, and the forming of the non-lyophobic area may include removing the lyophobic film formed of the molecular film provided on the underlying film of the liquid ejection surface of the nozzle plate and the lyophobic film formed of the molecular film provided on the surface opposite the liquid ejection surface of the nozzle plate are removed. With such a configuration, since it is not necessary to form the underlying film in the adhesion area of the nozzle plate to the passage forming board, the manufacturing process can be simplified. Moreover, since it is not necessary to selectively form the underlying film only in a predetermined area, it is possible to simplify the manufacturing process and reduce the manufacturing cost.

In a method of manufacturing a liquid ejecting head unit described above, the performing of the primer processing may include coating the primer liquid onto the non-lyophobic area of the liquid ejection surface of the nozzle plate and onto the non-lyophobic area of the surface opposite the liquid ejection surface of the nozzle plate. With such a configuration, it is possible to improve the adhesion intensity between the nozzle plate and the support member and between the nozzle plate and the passage forming board, thereby improving reliability.

In a method of manufacturing a liquid ejecting head unit described above, the forming of the non-lyophobic area may include forming a protective film to which the non-lyophobic area is opened in an area facing the liquid ejection surface and removing the lyophobic film to form the non-lyophobic area by subjecting the lyophobic film to plasma processing with the protective film interposed therebetween. With such a configuration, it is possible to remove the lyophobic film of a desired area and also perform the primer processing only in a predetermined area using the protective film. Moreover, since a new protective film is not necessary in the primer processing using the protective film used to remove the lyophobic film by the primer processing, it is possible to simplify the manufacturing process. Moreover, since it is not necessary to position the new protective film, the primer processing can be performed with high accuracy.

In a method of manufacturing a liquid ejecting head unit described above, the forming of the protective film may include attaching the protective film formed of a tape to the liquid ejection surface. With such a configuration, it is possible to form the non-lyophobic area easily and with high accuracy.

According to another aspect of the invention, there is provided a liquid ejecting head unit including: a liquid ejecting head which has a liquid ejection surface through which a nozzle opening is opened to eject a liquid; and a support member which is adhered onto the liquid ejection surface of the liquid ejecting head by an adhesive. In the liquid ejecting head unit, a lyophobic film is disposed on the liquid ejection surface and a non-lyophobic area having no lyophobic film is formed in an area to which the support member is adhered. In addition, in an interface between the non-lyophobic area and the adhesive, a primer remaining layer is disposed in the non-lyophobic area. According to such an aspect, the adhesion intensity between the liquid ejection surface and the support member can be improved and peeling can be prevented, thereby improving reliability.

### BRIEF DESCRIPTION OF THE DRAWINGS

The invention will be described with reference to the accompanying drawings, wherein like numbers reference like elements.

FIG. 1 is an exploded perspective view illustrating a head unit according to a first embodiment.

FIG. 2 is a perspective view illustrating the assembled head unit according to the first embodiment.

FIG. 3 is an exploded perspective view illustrating a printing head according to the first embodiment.

FIG. 4 is a sectional view illustrating the printing head according to the first embodiment.

FIGS. 5A, 5B, and 5C are sectional views illustrating a method of manufacturing the head unit according to the first embodiment.

FIGS. 6A and 6B are sectional views illustrating the method of manufacturing the head unit according to the first embodiment.

### DESCRIPTION OF EXEMPLARY EMBODIMENTS

Hereinafter, embodiments of the invention will be described.

### First Embodiment

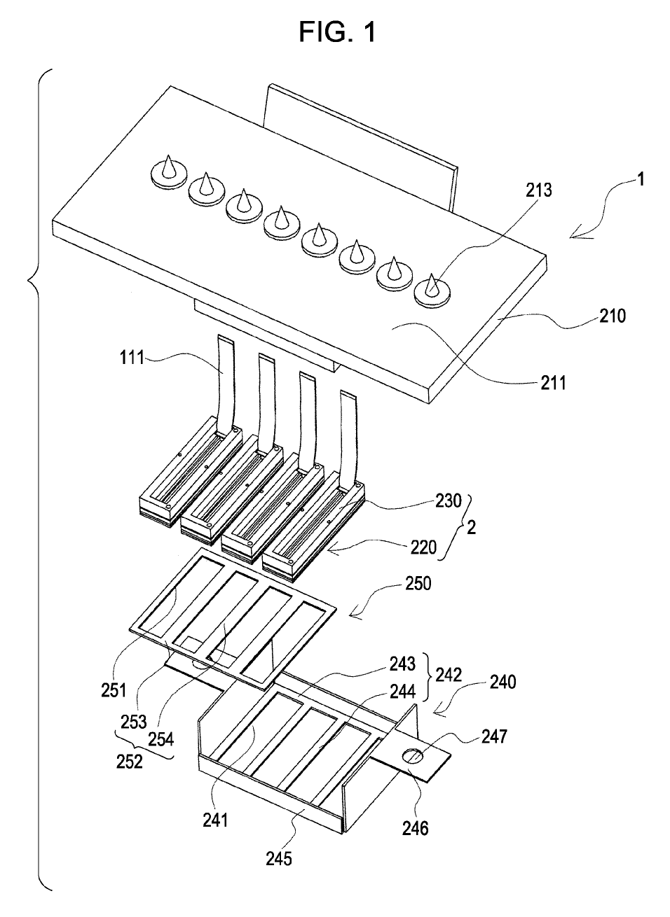

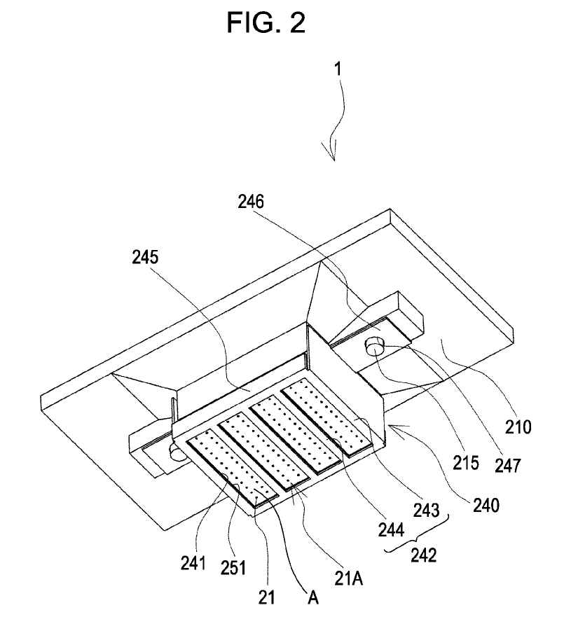

FIG. 1 is an exploded perspective view illustrating an ink jet printing head unit which is an example of a liquid ejecting head according to a first embodiment of the invention. FIG. 2 is a perspective view illustrating the assembled ink jet printing head unit.

As shown in the figures, a cartridge case 210 constituting an ink jet printing head unit 1 (hereinafter, referred to as a head unit) includes a cartridge mounting portion 211 mounted with ink cartridges (not shown) which are an ink supply member. For example, in this embodiment, the ink cartridges filled with respective ink of black and three colors are individually provided, and the ink cartridges of the respective ink are mounted in the cartridge case 210. A plurality of ink communication passages (not shown) of which one end is opened in the cartridge mounting portions 211 and the other end is opened in a head case described below are provided on the bottom surface of the cartridge case 210. In addition, ink supply needles 213 to be inserted into ink supply ports of the ink cartridges are each fixed to an opening of the ink communication passage of the cartridge mounting portion 211, with a filter (not shown) formed in the ink communication passage interposed therebetween in order to remove bubbles or foreign substances contained in the ink.

A plurality of ink jet printing heads 2 are fixed onto the bottom surface of the ink cartridge case 210.

The ink jet printing heads 2 are provided so as to correspond to ink cartridges 2A, 2B, and the like of the respective colors. In this embodiment, four ink jet printing heads 2 are provided in every ink jet printing head unit 1.

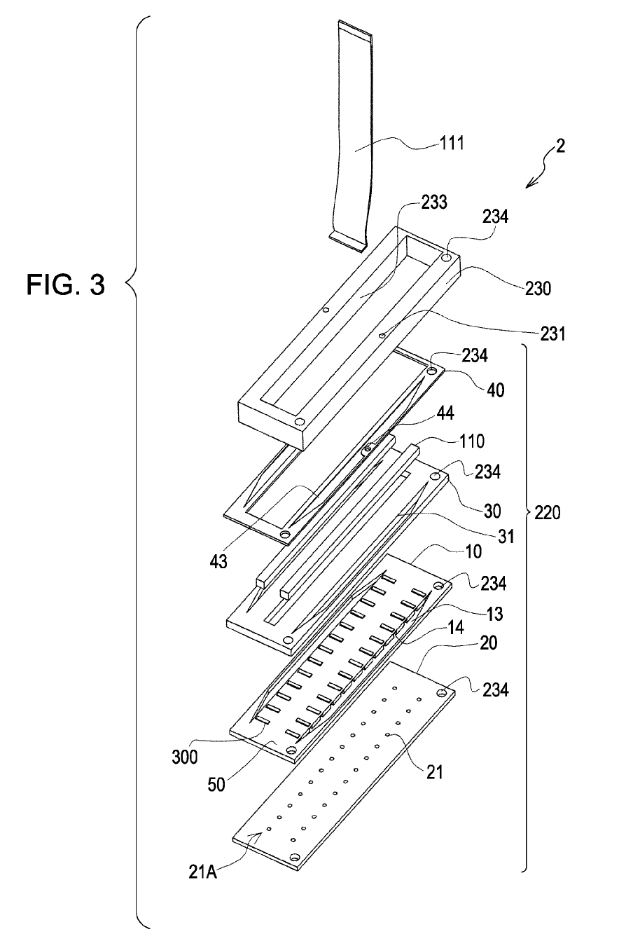

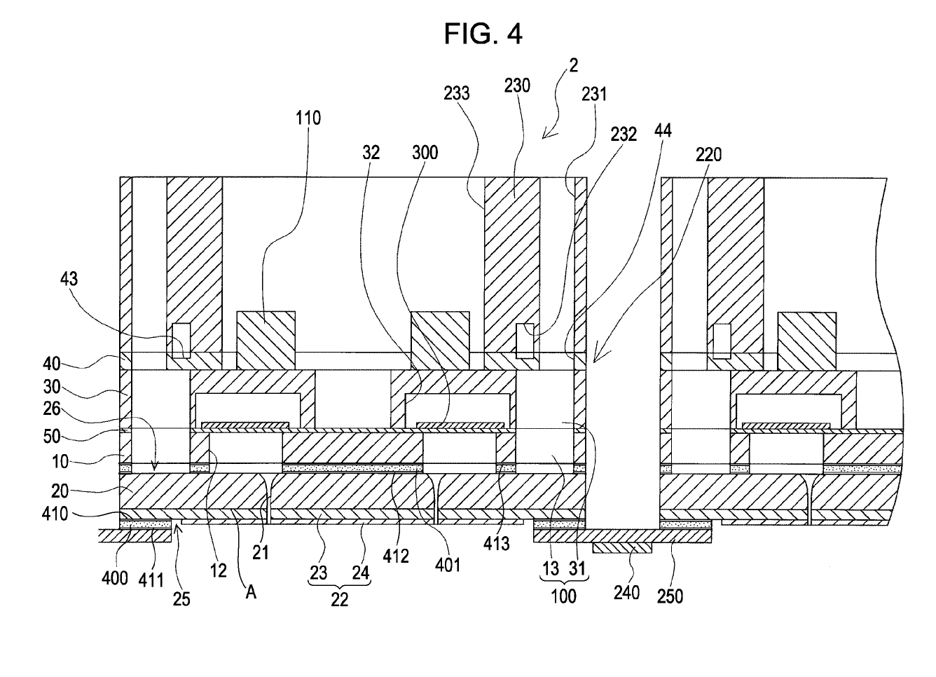

Here, the ink jet printing heads 2 which are one example of the liquid ejecting head according to this embodiment will be described in detail. FIG. 3 is an exploded perspective view illustrating each ink jet printing head. FIG. 4 is a section view illustrating each ink jet printing head. As shown in FIGS. 3 and 4, each of the ink jet printing heads 2 includes a head body 220 and a head case 230 provided opposite a liquid ejection surface A of the head body 220.

In this embodiment, a passage forming board 10 included in the head body 220 is formed of a silicon mono-crystal board. An elastic film 50 made of silicon dioxide is formed on one surface of the passage forming board 10. On the passage forming board 10, two rows of pressurizing chambers 12, which are partitioned by a plurality of partition walls, are arranged in the widthwise direction by performing anisotropic etching from the other surface of the passage forming board 10. In the outside in the lengthwise direction of the pressurizing chamber 12 of each row, there is formed a communication portion 13 which communicates with a reservoir portion 31 provided on a reservoir forming board 30 and constitutes a reservoir 100 as a common ink chamber of each pressuring chamber 12. In addition, the communication portion 13 communicates with one end in the lengthwise direction of each pressurizing chamber 12 with the ink supply passage 14 interposed therebetween. That is, in this embodiment, as a liquid passage formed in the passage forming board 10, the pressurizing chamber 12, the communication portion 13, and the ink supply passage 14 are provided.

A nozzle plate 20 through which nozzle openings 21 communicating with the ink supply passage 14 of each pressurizing chamber 12 in the opposite side are punched is fixed onto the opening surface of the passage forming board 10 by an adhesive or a thermally welding film. That is, in this embodiment, two nozzles rows 21A in which the nozzle openings 21 are disposed in one head body 220 are provided. In this embodiment, a surface to which the nozzle openings 21 of the nozzle plate 20 are opened is referred to as a liquid ejection surface A.

As such a nozzle plate 20, a metal board such as a silicon board or stainless steel (SUS) is exemplified.

A laminated film 22 having a lyophobic film is disposed on the liquid ejection surface A to which the nozzle openings 21 of the nozzle plate 20 are opened. In this embodiment, the laminated film 22 includes an underlying film 23 formed of a plasma-polymerized film which is formed across the liquid ejection surface A and also includes a lyophobic film 24 formed of a molecular film of metal alkoxide which is disposed in the middle of the underlying film 23.

For example, the underlying film 23 can be formed by polymerizing silicon using an argon plasma gas. In addition, the underlying film 23 also serves as improving adhesion of the lyophobic film 24 as the molecular film described below and the nozzle plate 20. The lyophobic film 24 is formed of the molecular film of metal alkoxide having a lyophobic property. For example, the lyophobic film 24 can be formed as follows: a silane coupling agent such as alkoxycilane is mixed with a solvent such as thinner to form a metal alkoxide solution and the metal alkoxide is polymerized by immersing the nozzle plate 20 in the metal alkoxide solution. The lyophobic film 24 formed of the molecular film can be formed thinner more than a known lyophobic film made by eutectic plating. At the same time, the lyophobic film 24 has an advantage in that it is possible to improve a friction-resistant property and a lyophobic property without deteriorating the lyophobic property even in a case in which the liquid ejection surface A is rubbed to clean a head surface. The lyophobic film 24 of the laminated film 22 formed in this manner is formed only in the middle of the liquid ejection surface A in accordance with a manufacturing method described in detail below. That is, on the liquid ejection surface A of the nozzle plate 20, a non-lyophobic area 25 in which the lyophobic film 24 is not disposed is formed along the outer circumference in four directions. In this embodiment, as the non-lyophobic area 25, the lyophobic film 24 is not provided and only the underlying film 23 is provided.

In the non-lyophobic area 25 of the liquid ejection surface A of the nozzle plate 20, a fixing plate 250 as a support member for supporting the ink jet printing head 2 is adhered by an adhesive 400. Specifically, as shown in FIGS. 1 and 4, the fixing plate 250, which is formed of a flat plate, includes nozzle openings 251 through which the nozzle openings 21 are exposed and an adhesive portion 252 which partitions the nozzle openings 251 and is adhered onto both ends of the nozzle row 21A of the liquid ejection surface A of the head body 220.

In this embodiment, the adhesive portion 252 includes a fixing frame portion 253 provided along the circumference of the liquid ejection surface A across the plurality of ink jet printing heads 2 and a fixing beam portion 254 which is extended between the adjacent ink jet printing heads 2 to partition the nozzle openings 251. In addition, the adhesive portion 252 including the fixing frame portion 253 and the fixing beam portion 254 is also adhered onto the liquid ejection surface A of the plural ink jet printing heads 2.

As described in detail below, in an interface between the non-lyophobic area 25 of the nozzle plate 20 and the adhesive 400, there is provided a primer remaining layer 410 in which a primer liquid is reacted with the adhesive 400 and remains by performing a primer process of coating the printer liquid onto the non-lyophobic area 25 of the nozzle plate 20 and adhering the non-lyophobic area 25 onto the fixing plate 250 by use of the adhesive 400.

In this embodiment, an area in which the adhesive 400 of the fixing plate 250 is adhered is also subjected to the primer process beforehand. In addition, a primer remaining layer 411 also remains in an interface between the fixing plate 250 and the adhesive 400.

In this embodiment, the nozzle plate 20 and the passage forming board 10 are adhered to each other by an adhesive 401. Accordingly, an area adhered to the passage forming board 10 of the nozzle plate 20 is also formed of a non-lyophobic area 26 in this manner. In this embodiment, an entire surface opposite the liquid ejection surface A of the nozzle plate 20 is formed of the non-lyophobic area 26. In addition, a primer remaining layer 412 is also present in an interface between the non-lyophobic area 26 of the nozzle plate 20 and the adhesive 401. Of course, a primer remaining layer 413 is also present in an interface between the passage forming board 10 and the adhesive 401.

It is possible to improve adhesion intensity of the nozzle plate 20 adhered with the passage forming board 10 and the fixing plate 250 to prevent detachment by subjecting the primer process to the non-lyophobic areas 25 and 26 of the nozzle plate 20 and the area in which the passage forming board 10 and the fixing plate 250 are adhered onto the nozzle plate 20 in order to form the primer remaining layers 410 to 413. In particular, in this embodiment, the adhesion area of the passage forming board 10 and the fixing plate 250 in addition to the non-lyophobic areas 25 and 26 of the nozzle plate 20 is also subjected to the primer process in order to prevent non-uniformity of the adhesion intensity of the interfaces between the adhesives 400 and 401 and the respective members. Accordingly, the area which has lower adhesion intensity than that of other areas can be reliably prevented from being easily detached.

As shown in FIG. 4, a piezoelectric element 300 is formed opposite the opening surface of the passage forming board 10 by sequentially laminating a lower electrode film made of metal, a piezoelectric layer made of lead zirconate titanate (PZT) or the like, and an upper electrode film made of metal on the elastic film 50. The reservoir forming board 30 having the reservoir portion 31 forming at least a part of the reservoir 100 is adhered onto the passage forming board 10 formed with the piezoelectric element 300. In this embodiment, the reservoir portion 31 is formed through the reservoir forming board 30 in the thickness direction so as to be formed in the widthwise direction of the pressurizing chamber 12, and also communicates with the communication portion 13 of the passage forming board 10 in the above-described manner to form the reservoir 100 as the common ink chamber of each pressurizing chamber 12.

A piezoelectric element supporting portion 32 having a space so as not to disturb movement of the piezoelectric element 300 is provided in an area opposite the piezoelectric element 300 of the reservoir forming board 30.

A drive IC110 for driving each piezoelectric element 300 is provided on the reservoir forming board 30. Respective terminals of the drive IC110 are connected to a drawn-out wiring drawn out from individual electrodes of each piezoelectric element 300 through a bonding wire (now shown). In addition, the respective terminals of the drive IC110 are connected to the outside through an external wiring 111 such as a flexible print cable (FPC), and receive various signals such a printing signal through the external wiring 111 from the outside.

A compliance board 40 is attached onto such a reservoir forming board 30. In an area opposite the reservoir 100 of the compliance board 40, an ink introducing port 44 for introducing ink to the reservoir 100 is formed through the compliance board 40 in the thickness direction. An area other than the ink introducing port 44 of the area opposite the reservoir 100 of the compliance board 40 is a flexible portion 43. The reservoir 100 is sealed by the flexible portion 43. The flexible portion 43 gives compliance to the inside of the reservoir 100.

The head case 230 is fixed onto a surface opposite the liquid ejection surface A of each head body 220, that is, onto the compliance board 40.

In the head case 230, there is provided an ink supply communication passage 231 which communicates with the ink introducing port 44 and an ink communication passage of the cartridge case 210 to supply the ink of the cartridge case 210 to the ink introducing port 44. In the head case 230, a concave portion 232 opposite the flexible portion 43 of the compliance board 40 is formed, and the flexible portion 43 is appropriately subjected to curved deformation. In addition, in the head case 230, there is provided a drive IC supporting portion 233 which penetrates the head case 230 in the thickness direction in an area opposite the drive IC110 disposed on the reservoir forming board 30. The external wiring 111 is inserted through the drive IC supporting portion 233 to be connected to the drive IC110.

The ink jet printing head 2 according to this embodiment receives the ink of the ink cartridge from the ink introducing port 44 through the ink communication passage and the ink supply communication passage 231. The inside of the ink jet printing head 2 from the reservoir 100 to the nozzle openings 21 is filled with ink. Afterward, a voltage is applied to each piezoelectric element 300 corresponding to the pressurizing chambers 12 in accordance with a printing signal transmitted from the drive IC110. In addition, the elastic film 50 and the piezoelectric elements 300 are subjected to curved deformation. Then, a pressure of the pressurizing chambers 12 increases and ink drops are ejected from the nozzle openings 21.

The above-described head body 220 is formed by simultaneously forming many chips on one silicon wafer, bonding and incorporating the nozzle plate 20 and the compliance board 40, and dividing it into every passage forming board 10 with a one chip size shown in FIG. 3.

Four ink jet printing heads 2 are fixed onto the bottom surface of the cartridge case 210. In this embodiment, the four ink jet printing heads 2 are arranged at a predetermined interval in an arrangement direction of the nozzle rows 21A. That is, eight nozzle rows 21A are arranged in one ink jet printing head 2 according to this embodiment. Reduction in yield can be prevented by designing multiple nozzle rows 21A constituted by the arranged nozzle openings 21 by use of a plurality of the ink jet printing heads 2, comparing to a case in which multiple nozzle rows 21A in one ink jet printing head 2. It is possible to increase the number of the head cases 220 (the ink jet printing heads 2) which can be formed from one silicon wafer by using the plurality of ink jet printing heads 2 in order to realize the multiple nozzle rows 21A. Accordingly, it is possible to reduce manufacturing cost by deceasing a wasteful area of the silicon wafer.

As described above, the four ink jet printing heads 2 are positioned and supported by the fixing plate 250 as the support member attached onto the liquid ejection surface A (non-lyophobic area 25) of the plurality of ink jet printing heads 2 by the adhesive 400.

In the ink jet printing head unit 1, as shown in FIGS. 2 and 3, a box-like cover head 240 for covering the plurality of ink jet printing heads 2 is provided opposite the ink jet printing heads 2 of the fixing plate 250. The cover head 240 includes a fixing portion 242 which is provided with openings 241 corresponding to the nozzle openings 251 of the fixing plate 250 and a sidewall portion 245 which is formed on the side surface of an ink drop ejection surface of the head body 220 so as to be curved along the periphery of the fixing plate 250.

In this embodiment, the fixing portion 242 includes a frame portion 243 corresponding to the fixing frame portion 253 of the fixing plate 250 and a beam portion 244 corresponding to the fixing beam portion 254 of the fixing plate 250 so as to partition the openings 241. The fixing portion 242 including the frame portion 243 and the beam portion 244 is adhered to the adhesive portion 252 of the fixing plate 250.

In the fixing portion 242 of the cover head 240, as shown FIG. 2, a support portion 246 is provided with a fixing hole 247 for fixing the position of the cover head 240 to the cartridge case 210. The support portion 246 is curved so as to protrude in the same direction as the plane direction of the liquid drop ejection surface from the sidewall portion 245. In this embodiment, the cover head 240 is fixed to the cartridge case 210. That is, a protruding portion 215 which protrudes in a side of the liquid ejection surface A and is inserted into the fixing hole 247 of the cover head 240 is provided in the cartridge case 210. In addition, the protruding portion 215 is inserted into the fixing hole 247 of the cover head 240 and the cover head 240 is fixed to the cartridge case 210 by heating and caulking the front end of the protruding portion 215.

In this way, since the fixing plate 250 is closely adhered to a gap between the liquid ejection surface A and the cover head 240 of the ink jet printing head 2, the printing medium is prevented from being inserted into the gap. Accordingly, it is possible to prevent deformation of the cover head 240 and jamming of paper-sheet. Moreover, since the sidewall portion 245 of the cover head 240 covers the outer periphery of the plurality of ink jet printing heads 2, ink can be reliably prevented from being leaked to the side surface of each of the ink jet printing heads 2.

In the example described above, the cover head 240 is adhered onto the surface opposite the head body 220 of the fixing plate 250, but the invention is not limited thereto. For example, the cover head 240 may not be adhered to the fixing plate 250, but is disposed so as to be spaced with the fixing plate 250 at a predetermined interval, and also may come in contact with the fixing plate 250.

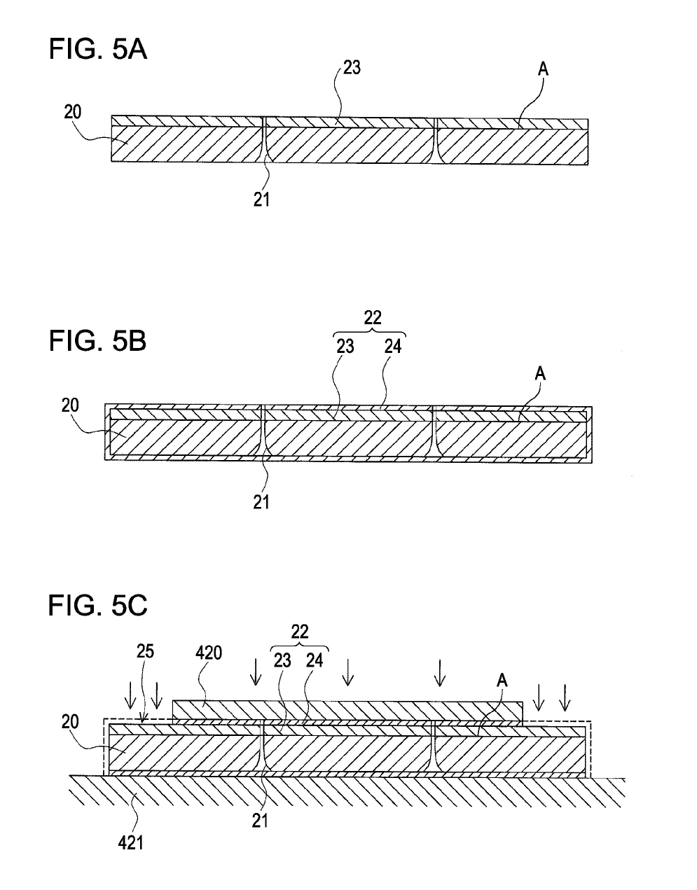

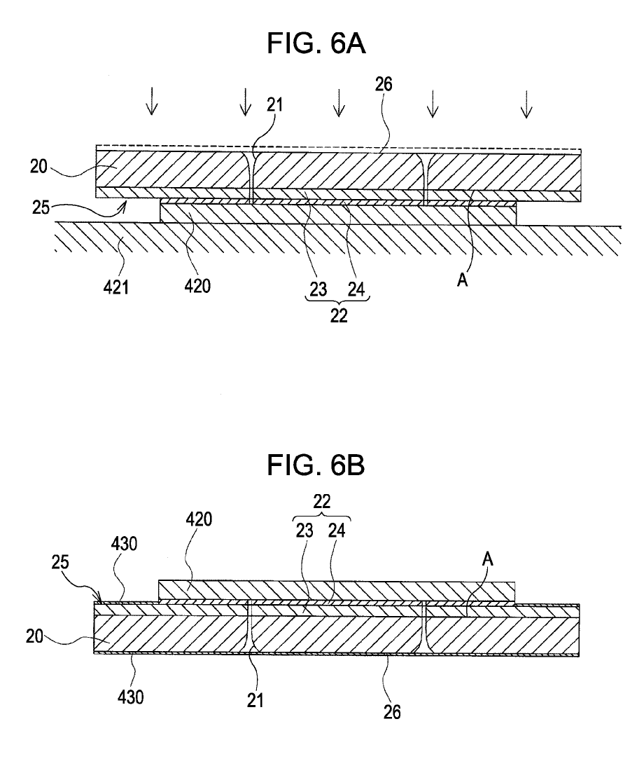

A method of manufacturing the ink jet printing head unit 1 according to the embodiment will be described. FIGS. 5A, 5B, and 5C and FIGS. 6A and 6B are sectional views illustrating the method of manufacturing the ink jet printing head unit according to the first embodiment of the invention.

First, as shown in FIG. 5A, the underlying film 23 formed of a plasma-polymerized film is disposed on the liquid ejection surface A of the nozzle plate 20 through which the nozzle openings 21 are formed. The underlying film 23 can be formed by polymerizing silicon with an argon plasma gas.

Next, as shown in FIG. 5B, the lyophobic film 24 formed of the metal alkoxide molecular film is formed on the underlying film 23 of the nozzle plate 20 and also formed across the surface on which the underlying film 23 is not formed. That is, the lyophobic film 24 is formed on the liquid ejection surface A of the nozzle plate 20 and also formed on a surface opposite the liquid ejection surface A. In this way, the laminated film 22 constituted by the underlying film 23 and the lyophobic film 24 is formed on the liquid ejection surface A of the nozzle plate 20. The method of forming the lyophobic film 24 formed of the molecular film is not particularly limited thereto. For example, the lyophobic film 24 may be formed as follows: a silane coupling agent such as alkoxycilane is mixed with a solvent such as thinner to form a metal alkoxide solution and the metal alkoxide is polymerized by immersing the nozzle plate 20 in the metal alkoxide solution.

Next, as shown in FIG. 5C, the non-lyophobic area 25 is formed on the liquid ejection surface A of the nozzle plate 20. Specifically, in the first place, a protective film 420 is formed in a predetermined area of the laminated film 22 on the liquid ejection surface A of the nozzle plate 20. The protective film 420 is formed in an area other than the non-lyophobic area 25 adhered to the fixing plate 250 of the nozzle plate 20. Such a protective film 420 is not particularly limited as long as a film has a resistance property to a plasma process and a primer liquid described below and has also a good peeling property. For example, a tape and a resist can be exemplified. If the tape is used as the protective film 420, the protective film 420 formed of the tape can be attached onto the liquid ejection surface A. Moreover, if the resist is used as the protective film 420, the resist is formed across the liquid ejection surface A and is subjected to patterning in a predetermined shape. In this embodiment, the protective film 420 formed of the tape is attached onto the liquid ejection surface A in consideration of job efficiency. As the protective film 420 formed of the tape, an ultraviolet peeling film (for example, E-6142S manufactured by Lintec Corporation) or a heat peeling film (for example, REVALPHA by manufactured by Lintec Corporation) is exemplified in consideration of a job property and a peeling property.

By using the tape or the resist as the protective film 420 in this manner, it is possible to selectively protect the non-lyophobic area 25 of the liquid ejection surface A of the nozzle plate 20, that is, only an area in which the lyophobic film 24 remains without covering the four sides of the lyophobic area A of the nozzle plate 20 with the protective film 420. In this way, the non-lyophobic area 25 can be easily formed. That is, as the protective film, a metal mask or the like may be taken into consideration. However, a protective film formed of the metal mask may cover the four sides of the liquid ejection surface A of the nozzle plate 20, and thus it is not easy to form the non-lyophobic area in the subsequent processes.

A surface opposite the liquid ejection surface A of the nozzle plate 20 provided with the protective film 420 is attached to a table 421, and the liquid ejection surface A of the nozzle plate 20 is subjected to the plasma process. In this way, the lyophobic film 24 on the area which is not covered with the protective film 420 of the liquid ejection surface A of the nozzle plate 20 is removed, thereby forming the non-lyophobic area 25. That is, the non-lyophobic area 25 of the liquid ejection surface A of the nozzle plate 20 is formed only of the underlying film 23.

Since the underlying film 23 of the nozzle plate 20 remains in the non-lyophobic area 25, the manufacturing process can be simplified, comparing to a case in which the underlying film 23 of the non-lyophobic area 25 is selectively removed. Moreover, the manufacturing process can be simplified, comparing to a case in which the underlying film 23 is selectively formed on the area (area other than the non-lyophobic area 25) to be formed of the laminated film 22.

Next, as shown in FIG. 6A, the lyophobic film 24 of the surface opposite the liquid ejection surface A of the nozzle plate 20 is removed. At this time, the underlying film 23 is not formed on the surface opposite the liquid ejection surface A. Accordingly, when the lyophobic film 24 is removed, the surface of the nozzle plate 20 is exposed. The underlying film 23 serves as improving adhesion between the lyophobic film 24, which is formed of the molecular film on the liquid ejection surface A, and the nozzle plate 20. Accordingly, since it is not necessary to provide the underlying film 23 on the surface opposite the liquid ejection surface a of the nozzle plate 20, the underlying film 23 is not present on the surface opposite the liquid ejection surface A. However, in forming the underlying film 23, the underlying film may be formed even on the surface opposite the liquid ejection surface A if forming the underlying film on the surface opposite the liquid ejection surface A of the nozzle plate 20 is effective. In this case, it is not necessary to remove the underlying film 23 opposite the liquid ejection surface A of the nozzle plate 20 when the lyophobic film 24 is removed. In this embodiment, the surface of the protective film 420 of the nozzle plate 20 is attached to the table 421, the surface opposite the liquid ejection surface A is subjected to the plasma process to remove the lyophobic film 24. In this manner, the non-lyophobic area 26 is formed on the surface opposite the liquid ejection surface A of the nozzle plate 20.

Next, as shown in FIG. 6B, a primer liquid 430 is coated on the non-lyophobic areas 25 and 26 of the nozzle plate 20 (primer processing step). Specifically, the primer liquid 430 is coated on the non-lyophobic area 25 opposite the liquid ejection surface A of the nozzle plate 20 and the non-lyophobic area 26 opposite the liquid ejection surface A. A method of coating the primer liquid on the non-lyophobic areas 25 and 26 of the primer liquid 430 is not particularly limited. For example, the primer liquid 430 may be ejected or flows out to the non-lyophobic areas 25 and 26. In addition, the nozzle plate 20 may be immerged into a tank filled with the primer liquid 430 to coat the primer liquid 430. As the primer liquid 430, a liquid which can improve adhesion between the nozzle plate 20 and the adhesives 400 and 401 is not particularly limited. For example, SH6020 (major component: γ-(2-aminoethyl) aminopropyltrimethoxysilane) or the like manufactured by Dow Corning Toray Co., Ltd. can be used.

That is, in this embodiment, when the lyophobic film 24 is removed, the protective film 420 for protecting the lyophobic film 24 serves as protecting the lyophobic film 24 upon coating the primer liquid 430 onto the non-lyophobic areas 25 and 26. Accordingly, it is not necessary to protect the lyophobic film 24 again by use of the protective film when the primer processing is performed, thereby simplifying the manufacturing cost and reducing cost. Of course, in addition to the protective film 420 used to remove the lyophobic film 24, a protective film for protecting the lyophobic film 24 may be formed when the primer processing is performed. Moreover, in a case in which a new protect film is formed upon performing the primer processing, this protect film is also removed after the primer processing.

Subsequently, as described above, the non-lyophobic area 26 of the nozzle plate 20 is adhered to the passage forming board 10 by the adhesive 401 to form the head body 220, and the head case 230 is adhered onto a surface opposite the nozzle plate 20 of the head body 220 to form the ink jet printing head 2. In addition, the fixing plate 250 is adhered to the on-lyophobic area 25 formed on the liquid ejection surface A of the nozzle plate 20 of the ink jet printing head 2 by the adhesive 400 to manufacture the ink jet printing head unit 1 shown in FIG. 1. Moreover, in this embodiment, the adhesion area of the passage forming board 10 and the fixing plate 250 adhered on the nozzle plate 20 are also subjected to the primer processing using the primer liquid 430, and then the nozzle plate 20 is adhered to the adhesion area.

In this embodiment, as described above, the laminated film 22 including the lyophobic film 24 is formed across the liquid ejection surface A of the nozzle plate 20, and then the non-lyophobic area 25 is formed by selectively removing the lyophobic film 24. Accordingly, it is possible to form the non-lyophobic area 25 easily and with high accuracy, comparing to a case in which the lyophobic film 24 (the laminated film 22) is selectively formed. Moreover, it is possible to improve the adhesion intensity between the nozzle plate 20 and the fixing plate 250 by subjecting the primer processing to the non-lyophobic area 25 adhered on the fixing plate 250 of the nozzle plate 20. Accordingly, the peeling can be prevented, thereby improving reliability.

### Other Embodiments

The first embodiment of the invention has been described, but the primary configuration of the invention is not limited to the above-described configuration. For example, in the above-described first embodiment, as the laminated film 22, the underlying film 23 formed of the plasma-polymerized film and the lyophobic film 24 of the metal alkoxide molecular film provided on the underlying film 23 are used, but the invention is not particularly limited thereto. As the lyophobic film, for example, a metal film containing a fluorinated polymer directly formed on the nozzle plate 20 may be used. A lyophobic film formed of such a metal film, for example, can be formed on the nozzle plate 20 so as to have a predetermined thickness in order to perform eutectic plating. The lyophobic film formed of the metal film is formed across the surface of the nozzle plate 20, the area in which the lyophobic film remains is protected by the protective film, and the other area in which the lyophobic film remains is removed by dry etching, wet etching, or the like to form the non-lyophobic area.

In the above-described first embodiment, the configuration in which the nozzle plate 20 provided with the nozzle openings 21 is formed as the element of the head body 220, but the invention is not particularly limited thereto. For example, there may be provided a configuration in which the nozzle openings are formed through the passage forming board as the head body, that is, the passage forming board and the nozzle plate are incorporated. In this case, the laminated film 22 including the lyophobic film 24 is formed on the liquid ejection surface A through which the nozzle openings of the passage forming board are formed. In addition, the non-lyophobic area 25 is formed on the liquid ejection surface A adhered with the fixing plate 250, and the non-lyophobic area 25 is subjected to the primer processing.

In the above-described first embodiment, the plurality of ink jet printing heads 2 are adhered to the fixing plate 250 by the adhesive 400. However, the fixing plate 250 may not be provided, but the plurality of ink jet printing heads 2 may be adhered to the cover head 240. That is, the cover head 240 may be a support member for supporting the liquid ejection surface A of the ink jet printing heads 2. Of course, one ink jet printing head 2 may be adhered to the support member such as the fixing plate 250 or the cover head 240.

In the above-described first embodiment, the ink jet printing head 2 including the curved vibrating piezoelectric element 300 has been exemplified, but the invention is not limited thereto. For example, the invention is applicable to a head unit including a vertical ink jet printing head extended in an axial direction by alternately laminating a piezoelectric material and an electrode forming material. In addition, the invention is also applicable to a head unit including an ink jet printing head for ejecting ink drops by use of bubbles generated by heat emitted from a heating element.

The head unit including the ink jet printing head for ejecting ink as a liquid ejecting head has been described as one example, but the invention may be applicable more widely to a method of manufacturing the liquid ejecting head unit including the liquid ejection head. As the liquid ejecting head, a printing head used in an image printing apparatus such as a printer, a color material ejecting head used to manufacture a color filter such as a liquid crystal display, an electrode material ejecting head used to form electrodes such as an organic EL display or a field emission display (FED), and a bio-organic matter ejecting head used to manufacture a bio-chip can be exemplified.

What is claimed is:

1. A method of manufacturing a liquid ejecting head unit which includes a liquid ejecting head having a liquid ejection surface through which a nozzle opening is opened to eject a liquid and a support member adhered onto the liquid ejection surface of the liquid ejecting head by an adhesive, the method comprising:
forming a lyophobic film on the liquid ejection surface;
forming a non-lyophobic area having no lyophobic film in an area in which the liquid ejection surface formed with the lyophobic film is adhered to the support member;
performing primer processing of coating a primer liquid onto the non-lyophobic area; and
adhering the support member to the non-lyophobic area of the liquid ejection surface using an adhesive.

2. The method according to claim 1, wherein the forming of the lyophobic film includes forming an underlying film across the liquid ejection surface and forming a lyophobic film formed of a metal alkoxide molecular film on the underlying film.

3. The method according to claim 2, wherein the forming of the non-lyophobic area includes removing only the molecular film formed on the underlying film of the liquid ejection surface.

4. The method according to claim 1,
wherein the liquid ejecting head includes a nozzle plate in which the nozzle opening is formed and a passage forming board which is adhered onto a surface opposite the liquid ejection surface of the nozzle plate by an adhesive and has a liquid passage,
wherein the forming of the lyophobic film includes forming the lyophobic film on the liquid ejection surface of the nozzle plate and on the surface opposite the liquid ejection surface, and
wherein the forming of the non-lyophobic area includes forming the non-lyophobic area in the adhesion area of the liquid ejection surface to the support member and on the surface opposite the liquid ejection surface.

5. The method according to claim 4, wherein the forming of the lyophobic film includes forming an underlying film only on the liquid ejection surface and forming a lyophobic film formed of a metal alkoxide molecular film across the surface of the nozzle plate, and
wherein the forming of the non-lyophobic area includes removing the lyophobic film formed of the molecular film provided on the underlying film of the liquid ejection surface of the nozzle plate and the lyophobic film formed of the molecular film provided on the surface opposite the liquid ejection surface of the nozzle plate are removed.

6. The method according to claim 4, wherein the performing of the primer processing includes coating the primer liquid onto the non-lyophobic area of the liquid ejection surface of the nozzle plate and onto the non-lyophobic area of the surface opposite the liquid ejection surface of the nozzle plate.

7. The method according to claim 1, wherein the forming of the non-lyophobic area includes forming a protective film to which the non-lyophobic area is opened in an area facing the liquid ejection surface and removing the lyophobic film to form the non-lyophobic area by subjecting the lyophobic film to plasma processing with the protective film interposed therebetween.

8. The method according to claim 7, wherein the forming of the protective film includes attaching the protective film formed of a tape onto the liquid ejection surface.

9. A liquid ejecting head unit comprising:
a liquid ejecting head which has a liquid ejection surface through which a nozzle opening is opened to eject a liquid; and
a support member which is adhered onto the liquid ejection surface of the liquid ejecting head by an adhesive,
wherein a lyophobic film is disposed on the liquid ejection surface and a non-lyophobic area having no lyophobic film is formed in an area to which the support member is adhered, and
wherein in an interface between the non-lyophobic area and the adhesive, a primer remaining layer is disposed in the non-lyophobic area.
